(19) United States
(12) Patent Application Publication
(10) Pub. No.: US 2020/0312193 A1
(43) Pub. Date: Oct. 1, 2020

(54) OPERATION SIMULATOR

(71) Applicant: TOYODA GOSEI CO., LTD., Kiyosu-shi (JP)

(72) Inventors: Masatoshi SHIMADA, Kiyosu-shi (JP); Takeshi FUJIWARA, Kiyosu-shi (JP); Daisuke MATSUDA, Kiyosu-shi (JP); Youngkwang PARK, Tokyo (JP)

(21) Appl. No.: 16/797,258

(22) Filed: Feb. 21, 2020

(30) Foreign Application Priority Data
Mar. 29, 2019 (JP) 2019-065348

(51) Int. Cl. G09B 23/32; G01L 1/14

(52) U.S. Cl. CPC G09B 23/32; G01L 1/146

(57) ABSTRACT

An operation simulator for an operation on living tissue includes a simulated body that simulates the living tissue, a soft membrane that supports the simulated body, and a load sensor that is configured to detect information based on a load applied to the simulated body.

### BACKGROUND

### 1. Field

The present disclosure relates to an operation simulator.

### 2. Description of Related Art

Japanese Laid-Open Patent Publication No. 2009-122130 discloses, as a type of operation simulator, a surgical operation training apparatus that is used in training for off-pump coronary bypass surgery.

The surgical operation training apparatus includes a simulated body, a holding body, a support body, a wire, and a control unit. The simulated body includes a simulated blood vessel and a simulated cardiac muscle. The holding body holds the simulated body and the support body movably supports the holding body. The wire joins the holding body to the support body. The control unit controls the movement of the holding body. The holding body includes a holding plate, a cylindrical central protrusion, a coil spring, and cylindrical corner protrusions. The holding plate is attached to the lower surface of the simulated cardiac muscle. The central protrusion protrudes downward from the central section of the lower surface of the holding plate. The coil spring is attached to the central protrusion. The corner protrusions protrude downward from the respective corner sections of the lower surface of the holding plate. The wire is made of a shape memory alloy such as Ti—Ni or Ti—Ni—Cu, which contracts when heated. The wire joins the corner sections to the support body. The control unit controls the movement of the holding body by changing the state of electric current supply to the wire and thus changing the shape of the wire. The surgical operation training apparatus is capable of moving the simulated body, which is held by the holding body, at 60 to 100 beats per minute (BPM), which corresponds to a typical adult resting heart rate.

Operation may involve manipulation such as pressing living tissue using an operation tool, such as a pair of forceps or a needle holder, or pulling the living tissue using a needle or suture. To decrease undesirable load on the living tissue, it is preferable that such manipulation be conducted without excessively pressing the living tissue.

### SUMMARY

Accordingly, it is an objective of the present disclosure to provide an operation simulator that improves techniques of decreasing undesirable load on living tissue.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an operation simulator for an operation on living tissue is provided. The operation simulator includes a simulated body that simulates the living tissue, a soft membrane that supports the simulated body, and a load sensor that is configured to detect information based on a load applied to the simulated body.

Other features and aspects will be apparent from the following detailed description, the drawings, and the claims.

### BRIEF DESCRIPTION OF THE DRAWINGS

FIG. 1 is a perspective view showing an operation simulator according to a first embodiment.

FIG. 2 is a cross-sectional view taken along line 2-2 of FIG. 1.

FIG. 3 is a plan view showing a simulated body and a soft membrane according to the first embodiment.

FIG. 4 is a cross-sectional view taken along line 4-4 of FIG. 3.

FIG. 5 is a block diagram representing the operation simulator according to the first embodiment,

FIG. 6 is a plan view showing a simulated body and a soft membrane according to a second embodiment.

FIG. 7 is a block diagram representing the operation simulator according to the second embodiment.

FIG. 8 is a plan view showing a simulated body and a soft membrane according to a third embodiment.

FIG. 9 is a cross-sectional view taken along line 9-9 of FIG. 8.

FIG. 10 is a block diagram representing the operation simulator according to the third embodiment.

FIG. 11 is a cross-sectional view showing an operation simulator according to a fourth embodiment,

FIG. 12 is a block diagram representing the operation simulator according to the fourth embodiment

FIG. 13 is a plan view showing a simulated body and a soft membrane according to a modification of the first embodiment.

Throughout the drawings and the detailed description, the same reference numerals refer to the same elements. The drawings may not be to scale, and the relative size, proportions, and depiction of elements in the drawings may be exaggerated. for clarity, illustration, and convenience.

### DETAILED DESCRIPTION

This description provides a comprehensive understanding of the methods, apparatuses, and or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art,

### First Embodiment

An operation simulator according to a first embodiment will now be described. In the present embodiment, an operation simulator will be described that is used in training for anastomosis of cardiac blood vessels, or, more specifically, off-pump coronary bypass surgery.

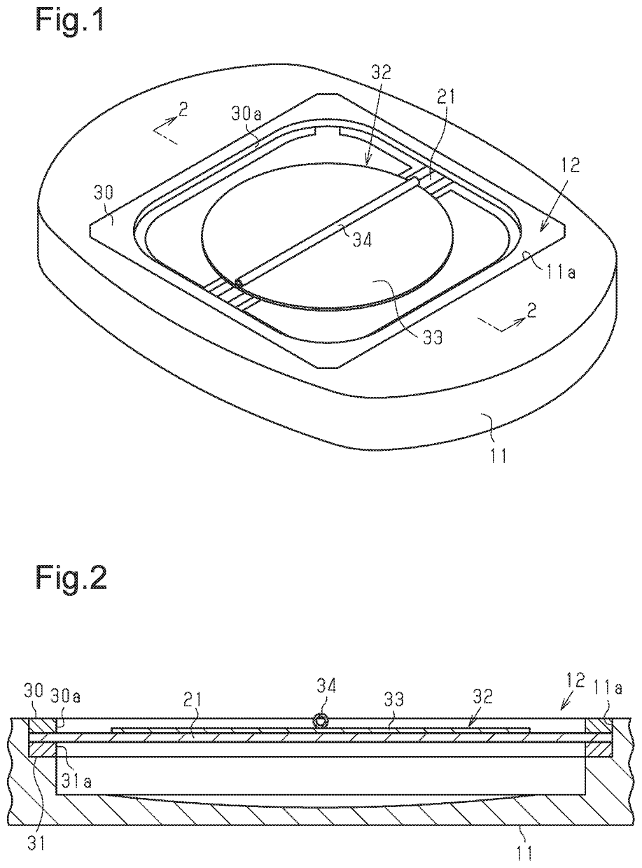

As shown in FIGS. 1 and 2, an operation simulator includes a case 11 and a flat plate-like body portion 12. The case 11 has an opening 11a in an upper section of the case 11. The body portion 12 is attached to the upper section of the case 11 in a replaceable manner to block the opening 11a of the case 11. The interior of the case 11 has space for allowing the body portion 12 to be displaced vertically.

The body portion 12 includes a soft membrane 21. The soft membrane 21 is made of elastomer and functions as a dielectric elastomer actuator.

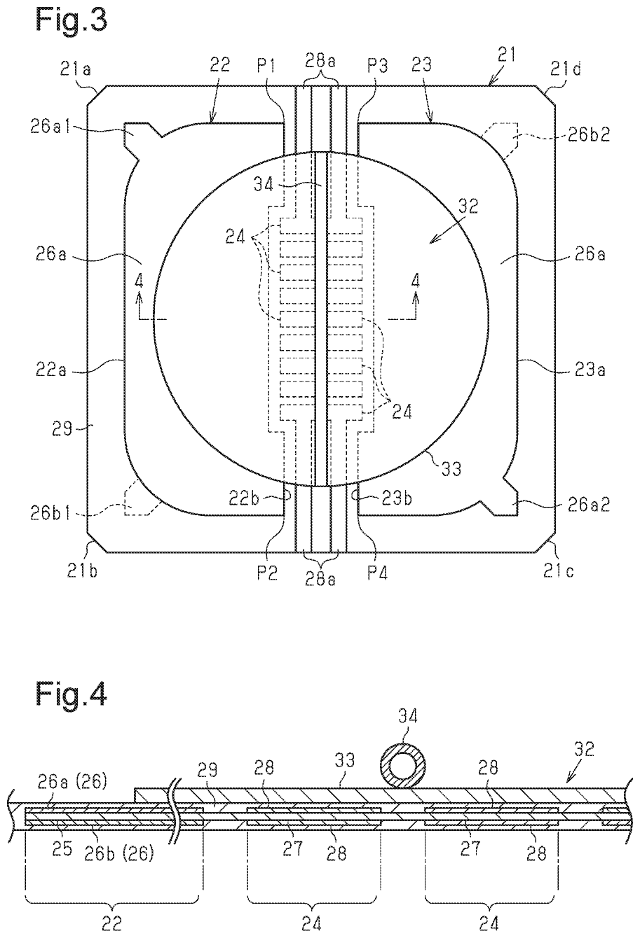

With reference to FIGS. 3 and 4, the soft membrane 21 has a square plate-like shape in a plan view. The soft membrane 21 has a first drive portion 22 and a second drive portion 23 each serving as a drive portion for driving the soft membrane 21. The first drive portion 22 and the second drive portion 23 are arranged separately on the left side and the right side, respectively, in a direction along the surface of the soft membrane 21. Sensor portions 24 are disposed between the first drive portion 22 and the second drive portion 23 in the direction along the surface of the soft membrane 21.

As illustrated in FIG. 3, the first drive portion 22 has an outer peripheral edge section 22a and an opposed edge section 22b. The outer peripheral edge section 22a substantially has a U shape extending along the edge of the soft membrane 21. The opposed edge section 22b couples the opposite ends P1, P2 of the outer peripheral edge section 22a together and has a middle section that is partially recessed toward the outer peripheral edge section 22a. Similarly, the second drive portion 23 has an outer peripheral edge section 23a and an opposed edge section 23b. The outer peripheral edge section 23a. substantially has a U shape extending along the edge of the soft membrane 21. The opposed edge section 23b couples the opposite ends P3. P4 of the outer peripheral edge section 23a together and has a middle section that is partially recessed toward the outer peripheral edge section 23a. The opposed edge sections 2b, 23b of the first and second drive portions 22, 23 are spaced apart and opposed to each other.

The sensor portions 24 are arranged between the recessed middle section of the opposed edge section 22b of the first drive portion 22 and the recessed middle section of the opposed edge section 23b of the second drive portion 23. Regarding directions along the surface of the soft membrane 21, the direction in which the first and second drive portions 22, 23 are arranged is defined as the transverse direction. A direction perpendicular to the transverse direction is defined as a longitudinal direction. The first embodiment employs eighteen sensor portions 24, with every corresponding two of the sensor portions 24 aligned in the transverse direction and nine in the longitudinal direction.

With reference to FIG. 4, the first drive portion 22 and the second drive portion 23 each include a drive dielectric layer 25 and two drive electrode layers 26. The drive electrode layers 26 sandwich the drive dielectric layer 25. Specifically, the drive electrode layers 26 are a positive electrode layer 26a and a negative electrode layer 26b. The corresponding ones of the layers of the first and second drive portions 22, 23 are arranged to be flush with each other. Each of the sensor portions 24 includes a sensor dielectric layer 27 and two sensor electrode layers 28. The sensor electrode layers 28 sandwich the sensor dielectric layer 27. The sensor dielectric layers 27 and the drive dielectric layers 25 are formed simultaneously and continuously.

A common insulating layer 29 is disposed on the opposite sides of the first drive portion 22, the second drive portion 23, and the sensor portions 24 in the thickness directions of the first and second drive portions 22, 23 and the sensor portions 24. The outer peripheral edge section of the soft membrane 21 and the sections between any adjacent ones of the first drive portion 22, the second drive portion 23, and the sensor portions 24 are constituted solely by the insulating layer Specifically, since the insulating layer 29 is transparent, the positive electrode layers 26a, which are located inside the insulating layer 29, are shown by the solid lines in FIGS. 1 and 3.

The drive dielectric layers 25 and the sensor dielectric layers 27 are made of dielectric elastomer containing cross-linked polyrotaxane. Specifically, the dielectric elastomer consists of polyethylene glycol as a linear molecule, cyclodextrin as a cyclic molecule, and adamantanamine as a blocking group. The thickness of each of the drive dielectric layers 25 and sensor dielectric layers 27 is, for example, 1 to 1000 μm.

The drive electrode layers 26 and the sensor electrode layers 28 are made of conductive elastomer containing insulating polymer and conductive filler. Polyrotaxane is used as the insulating polymer. Ketjen black (registered trademark) is used as the conductive filler. The thickness of each of the drive electrode layers 26 and sensor electrode layers 28 is, for example, 0.1 to 1000 μm.

With reference to FIG. 3, the positive electrode layer 26a of the first drive portion 22 has a contact 26a1. The contact 26a1 protrudes toward a first corner section 21a of the soft membrane 21 and is exposed to the exterior. The negative electrode layer 26b of the first drive portion 22 has a contact 26b1. The contact 26b1 protrudes toward a second corner section 21b of the soft membrane 21 and is exposed to the exterior.

The positive electrode layer 26a of the second drive portion 23 has a contact 26a2. The contact 26a2 protrudes toward a third corner section 21c of the soft membrane 21 and is exposed to the exterior. The negative electrode layer 26b of the second drive portion 23 has a contact 26b2. The contact 26b2 protrudes toward a fourth corner section 21d of the soft membrane 21 and is exposed to the exterior.

In the soft membrane 21, the first corner section 21a and the third corner section 21c are located diagonally opposite to each other. The second corner section 21b and the fourth corner section 21d are located diagonally opposite to each other. The sensor electrode layers 28 of each sensor portion 24 each have a contact 28a. The contact 28a passes between the opposed edge sections 22b, 23b of the first and second drive portions 22, 23 and extends to the edge section of the soft membrane 21, with a distal section of the contact 28a exposed to the exterior. Disposing the contacts 28a in the sensor electrode layers 28 of the respective sensor portions 24 enables independent measurement of the capacitances of the eighteen sensor portions 24.

As shown in FIGS. 1 and 2, the body portion 12 includes an upper frame member 30 and a lower frame member 31. The upper and lower frame members 30, 31 support the peripheral edge section of the soft membrane 21 in a manner sandwiching the soft membrane 21 from the opposite sides in the thickness direction. The upper frame member 30 is shaped like a square plate with a central hole 30a in a plan view. The central hole 30a has a round-cornered square shape in a plan view. Similarly, the lower frame member 31 is shaped like a square plate with a central hole 31a, in a plan view. The central hole 31a has a round-cornered square shape in a plan view. The upper and lower frame members 30, 31 are fixed to the peripheral edge sections of the opposite main surfaces of the soft membrane 21 using adhesive.

The central holes 30a, 31a are arranged such that the first drive portion 22, the second drive portion 23, and the sensor portions 24 of the soft membrane 21 are located inside the central holes 30a, 31a. Although not illustrated, the upper frame member 30 and the lower free member 31 each have a connecting portion. The connecting portions are connected to the contacts 26a1, 26a2, 26b1, 26b2, 28a.

As shown in FIGS. 1 to 4, the simulated body 32 is fixed to a central section of the upper surface of the soft membrane 21. The simulated body 32 simulates a section of living tissue. The simulated body employed by the first embodiment simulates a section of a cardiac surface on which the coronary arteries are exposed. The simulated body 32 has a soft sheet-like simulated cardiac muscle 33 and a cylindrical simulated blood vessel 34. In a plan view, the simulated cardiac muscle 33 has a circular shape smaller than the central hole 30a. of the upper frame member 30. The simulated blood vessel 34 is fixed to a middle section of the upper surface of the simulated cardiac muscle 33. The simulated cardiac muscle 33 and the simulated blood vessel 34 are both formed by an elastic member made of silicone elastomer or the like.

With reference to FIG. 3, the simulated body 32 is placed on the soft membrane 21 such that the entire simulated cardiac muscle 33 spreads over the first and second drive portions 22, 23, which are adjacent to each other. The simulated body 32 is also fixed to the insulating layer 29 of the soft membrane 21 using adhesive to be supported by the soft membrane 21. The simulated blood vessel 34 is arranged to pass between the first drive portion 22 and the second drive portion 23 in a direction along the surface of the soft membrane 21 and between the adjacent pairs of the sensor portions 24 in the transverse direction.

The thickness of the simulated body 32 is, for example, 2 mm.

Specifically, it is preferable that the soft membrane 21 have such elasticity characteristics that, if a load of 10 g is applied to a region of 20 mm in diameter in the soft membrane 21 in which the simulated body 32 is arranged, the region is displaced downward by an amount of 1 to 100 mm. The soft membrane 21 of the first embodiment has such elasticity characteristics that the region is displaced downward by an amount of approximately 10 mm.

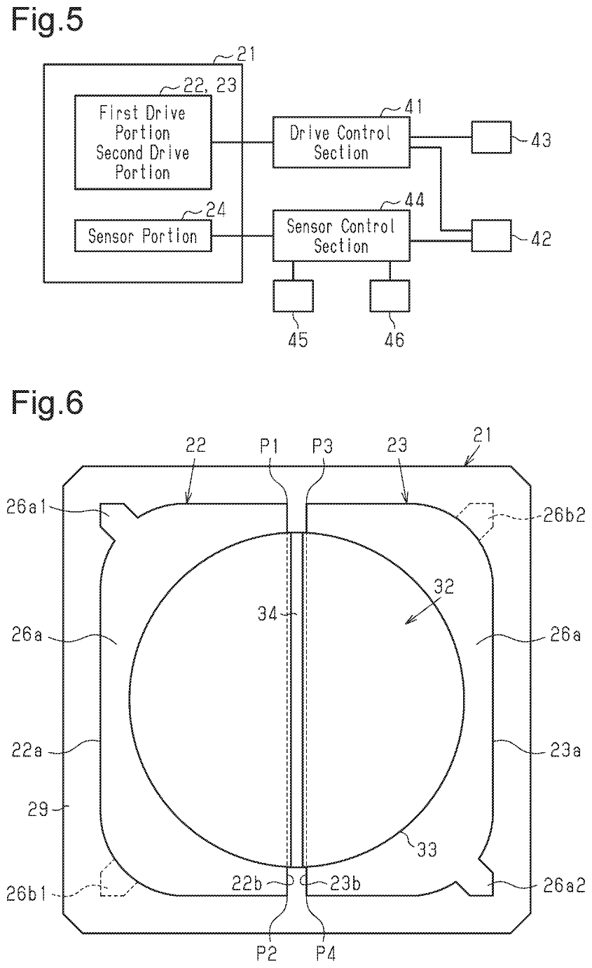

As illustrated in FIG. 5, a drive control section 41 is electrically connected to the first and second drive portions 22, 23 of the soft membrane 21 through the contacts 26a1, 26a2, 26b1, 26b2. The drive control section 41 controls the manner in which the first and second drive portions 22, 23 are driven. A power source 42 is electrically connected to the drive control section 41. An input device 43 such as a tablet terminal is also connected to the drive control section 41.

The drive control section 41 is configured to control the manner of applying DC voltage at the time of applying a DC voltage in a predetermined range (100 to 1500 V, for example) from the power source 42 between the drive electrode layers 26 of each of the first and second drive portions 22, 23, based on an input signal from the input device 43. Specifically, the drive control section 41 variably sets the voltage in the frequency range of 0 to 5 Hz, thereby driving the first and second drive portions 22, 23 in the range of 0 to 300 beats per minute (BPM).

A sensor control section 44 is connected to the respective sensor portions 24 of the soft membrane 21 through the contacts 28a. The sensor control section 44 is configured to estimate the amount of deformation of the soft membrane 21 for every one of the sections corresponding to the locations of the sensor portions 24 based on signals output by the sensor portions 24. The power source 42 is electrically connected to the sensor control section 44. A notification device 45 and a recording device 46 are also connected to the sensor control section 44. The notification device 45 is configured to display and announce the estimated deformation amounts or information based on the estimated deformation amounts. The recording device 46 is configured to record and accumulate the estimated deformation amounts or information based on the estimated deformation amounts. In the first embodiment, the sensor portions 24, the sensor control section 44, the notification device 45, and the recording device 46 constitute a load detecting device.

The sensor control section 44 is configured to apply an AC voltage between the sensor electrode layers 28 of the respective sensor portions 24, obtain the capacitance between the sensor electrode layers 28 of each of the sensor portions 24, and estimate the amount of deformation of the soft membrane 21 for every one of the sections corresponding to the locations of the sensor portions 24. The capacitance between the sensor electrode layers 28 of each sensor portion 24 is a parameter inversely proportional to the distance between the sensor electrode layers 28 and directly proportional to the surface area by which the sensor electrode layers 28 are opposed to each other. The capacitance thus changes in correspondence with the shape of the sensor portion 24.

For example, if a load caused by external force is applied to the soft membrane 21 and deforms any one of the sensor portions 24 in a manner extending in a direction along the surface, the distance between the associated sensor electrode layers 28 decreases, thus increasing the capacitance between the sensor electrode layers 28. As is clear from this, there is an exchangeable correlation between the shape of each sensor portion 24 and the capacitance between the associated sensor electrode layers 28.

The sensor control section 44 stores relationship information such as a map representing the relationship between the capacitance between the sensor electrode layers 28 of each sensor portion 24 and the deformation amount of the sensor portion 24 or expressions representing the relationship. Based on the capacitance between the sensor electrode layers 28 and the relationship information, the sensor control section 44 estimates the deformation amount of the corresponding sensor portion 24. In the first embodiment, the deformation amount of each sensor portion 24 corresponds to information based on a load applied to the simulated body 32. In the first embodiment, the sensor portions 24 and the sensor control section 44 constitute a load sensor that detects the information based on the load applied to the simulated body 32.

The drive control section 41 and the sensor control section 44 may each be circuitry including: 1) one or more processors that operate according to a computer program (software); 2) one or more dedicated hardware circuits (application specific integrated circuits: ASIC) that execute at least part of various processes, or 3) a combination thereof. The processor includes a CPU and memories such as a RAM and a ROM. The memories store program codes or commands configured to cause the CPU to execute processes. The memories, or computer readable media, include any type of media that are accessible by general-purpose computers and dedicated computers.

The operation of the present embodiment will now be described.

In the training for coronary bypass surgery using the operation simulator, the drive control section 41 controls the manners in which the first and second drive portions 22, 23 are electrified. This controls the manners in which the first and second drive portions 22, 23 are driven, thus controlling the movement of the soft membrane 21 and the movement of the simulated body 32.

In other words, by applying DC voltage between the positive electrode layer 26a and the negative electrode layer 26b of the first drive portion 22, force acting to bring positive potentials closer to negative potentials is produced in the first drive portion 22. The force compresses the drive dielectric layer 25 in the thickness direction and extends the drive dielectric layer 25 in a direction along the surface of the drive dielectric layer 25. This decreases the elastic force of the first drive portion 22, so that the middle section of the first drive portion 22 is displaced downward due to the weight of the first drive portion 22.

Afterwards, by interrupting the voltage application to the first drive portion 22, the thickness of the drive dielectric layer 25 is restored. This recovers the elastic force of the first drive portion 22, thus displacing the first drive portion 22 upward.

Both when voltage is applied to the second drive portion 23 and when such voltage application is interrupted, the second drive portion 23 is displaced in a similar manner to the first drive portion 22. In the first embodiment, voltage is applied to the first drive portion 22 and the second drive portion 23 in different phases. In this manner, the first drive portion 22 and the second drive portion 23 of the soft membrane 21 are raised and lowered in an alternating manner. This enables the simulated body 32, which is fixed to the soft membrane 21 to spread over the first drive portion 22 and the second drive portion 23, to move in a manner simulating relaxation and contraction of the heart.

An operator, such as a trainee, performs a simulated operation of anastomosis assuming a case of off-pump coronary bypass surgery by joining a separately prepared simulated blood vessel to the simulated blood vessel 34 of the simulated body 32, which moves in a manner simulating relaxation and contraction of the heart. The simulated operation involves manipulation including pressing and pulling the simulated body 32 using operation tools such as a pair of forceps or a needle holder. The manipulation applies a load caused by external force to the simulated body 32, thus applying the load to the soft membrane 21 to which the simulated body 32 is fixed. This deforms the sensor portions 24 in correspondence with the positions at which the load acts on the soft membrane 21, the direction of the load, and the intensity of the load.

The sensor control section 44 estimates the deformation amount of each sensor portion 24 from the capacitance between the sensor electrode layers 28 of the sensor portion 24. The sensor control section 44 then causes the notification device 45 to display load information and the recording device 46 to record the load information. The load information represents the positions in the simulated body 32 where the load is applied and the direction and intensity of the load based on the changes of the (estimated) deformation amounts of at least four of the sensor portions 24 in the vicinity of the site of anastomosis as the time elapses during the simulated operation.

Referring to the load information displayed by the notification device 45 and the load information memorized by the recording device 46, the operator repeatedly performs the simulated operation to improve techniques of decreasing undesirable load on living tissue. For example, by checking the notification device 45 during the simulated operation, the operator monitors how much load is being applied to the simulated body 32 while performing manipulation for the operation. Also, the operator checks the load information recorded by the recording device 46, as well as a video recorded during the simulated operation. The operator even compares the load information and video with the load information and video obtained from a simulated operation performed by a different operator, such as a skilled operator. In these manners, the operator identifies points that need improvement.

The present embodiment has the following advantages.

(1) The operation simulator includes the simulated body 32, the soft membrane 21, and the load sensor. The simulated body 32 simulates living tissue and the soft membrane 21 supports the simulated body 32. The load sensor is configured to detect information based on a load applied to the simulated body 32.

The operation simulator, as configured in the above-described manner, detects information based on the load applied to the simulated body during a simulated operation. The detected information is used as reference for determining the intensity of undesirable load on living tissue or improving manipulation techniques that decrease such undesirable load on living tissue. As a result, the operation simulator, which is configured as has been described, improves the techniques of decreasing undesirable load on living tissue.

(2) The soft membrane 21 includes the sensor portions 24 as components of the load sensor. Each of the sensor portions 24 includes the sensor dielectric layer 27 and the sensor electrode layers 28. The sensor dielectric layer 27 is made of dielectric elastomer. The sensor electrode layers 28 are made of conductive elastomer and sandwich the sensor dielectric layer 27.

The above-described configuration enables detection of a change in the load applied to the soft membrane 21 through the simulated body 32 as a change in the capacitance between the sensor electrode layers 28 of each sensor portion 24. The operation simulator is thus adapted for quantitative determination of the load applied to the simulated body 32. Also, since the sensor portions 24 are provided integrally with the soft membrane 21, the operation simulator has a fewer number of components.

(3) The soft membrane 21 includes the sensor portions 24.

The information detected by the operation simulator, which has the above-described configuration, is also used as reference for determining the positions at which the load is applied. As a result, the operation simulator effectively improves the techniques of decreasing undesirable load on living tissue.

(4) The soft membrane 21 includes the first drive portion 22 and the second drive portion 23. The first and second drive portions 22, 23 are configured to drive the soft membrane 21 to move the simulated body 32 in a manner simulating relaxation and contraction of living tissue. Each of the first and second drive portions 22, 23 is a dielectric elastomer actuator that includes the drive dielectric layer 25 and the drive electrode layers 26. The drive dielectric layer 25 is made of dielectric elastomer. The drive electrode layers 26 are made of conductive elastomer and sandwich the drive dielectric layer 25.

The above-described configuration is usable in a simulated operation on moving living tissue as in off-pump coronary bypass surgery. Also, the first and second drive portions 22, 23, as configured in the above-described manner, increase the movement speed, that is, responsiveness, of the simulated body 32, compared to actuators made of a shape memory alloy. As a result, the operation simulator is adapted particularly for simulating an operation on a patient with a high heart rate, such as a child. Also, the configuration is simple yet capable of ensuring stable movement of the simulated body 32.

(5) The sensor portions 24 are provided separately from the first and second drive portions 22, 23.

The above-described configuration decreases the influence on the change in capacitance of each sensor portion 24 by the voltages applied to the first and second drive portions 22, 23. This facilitates detection of a change in the capacitance of each sensor portion 24 based on a change in the load applied to the soft membrane 21 through the simulated body 32.

(6) The soft membrane 21 includes the multiple drive portions (the first drive portion 22 and the second drive portion 23), which are arranged separately in a direction along the surface of the soft membrane 21. The above-described configuration allows the drive portions to apply force, separately from each other, to different sections of the simulated body 32. Therefore, by moving the drive portions in different manners, the simulated body 32 is moved in complicated patterns. This brings the movement of the simulated body 32 closer to the actual relaxation and contraction of living tissue.

(7) The operation simulator includes the notification device 45. The notification device 45 is configured to announce the information based on the load applied to the simulated body 32.

The above-described configuration allows the operator to check the notification device 45 during a simulated operation to monitor how much load is applied to the simulated body 32 while performing manipulation for the operation.

(8) The operation simulator includes the recording device 46. The recording device 46 is configured to record the information based on the load applied to the simulated body 32.

The above-described configuration allows the operator to check the load information recorded by the recording device 46 and compare the load information, which is from a simulated operation performed by the operator, with the load information from a simulated operation performed by a different operator, such as a skilled operator. This allows the operator to determine points that need improvement,

### Second Embodiment

An operation simulator according to a second embodiment will hereafter be described. The operation simulator of the second embodiment has a load sensor configured differently from the load sensor according to the first embodiment. The load sensor is disposed in the soft membrane 21. The description below will thus focus on this difference. Components of the second embodiment that are identical with or correspond to corresponding components of the first embodiment will be cited with reference numerals that are common with corresponding reference numerals of the first embodiment. Description of these components will not be repeated.

As shown in FIG. 6, the soft membrane 21 of the second embodiment lacks the sensor portions 24, unlike the soft membrane 21 of the first embodiment. The first drive portion 22 and the second drive portion 23 are provided substantially in the entire soft membrane 21 such that the opposed edge sections 22b, 23b extend linearly. In the second embodiment, the first drive portion 22 and the second drive portion 23 are configured to function also as the sensor portions 24 by using the self-sensing characteristics that the first and second drive portions 22, 23 have as dielectric elastomer actuators.

The capacitance between the drive electrode layers of each of the dielectric elastomer actuators (hereinafter, DEAs) is a parameter inversely proportional to the distance between the drive electrode layers and directly proportional to the surface area by which the drive electrode layers are opposed to each other. The capacitance thus changes in correspondence with the shape of the DEA. Therefore, between the voltage applied to the DEA and the capacitance, there is a correlation in which one becomes greater as the other one becomes greater. Also, there is an exchangeable correlation between the shape (the deformation amount) of the DEA and the capacitance.

The deformation amount of the DEA changes when external force acts on the DEA in the direction in which the drive electrode layers are stacked together. As a result, the capacitance of the DEA also changes regardless of a constant voltage being applied to the DEA. The difference between the capacitance in the state with the external force acting on the DEA and the capacitance in the state without such external force is thus considered to be a parameter that indicates the intensity of the external force acting on the DEA.

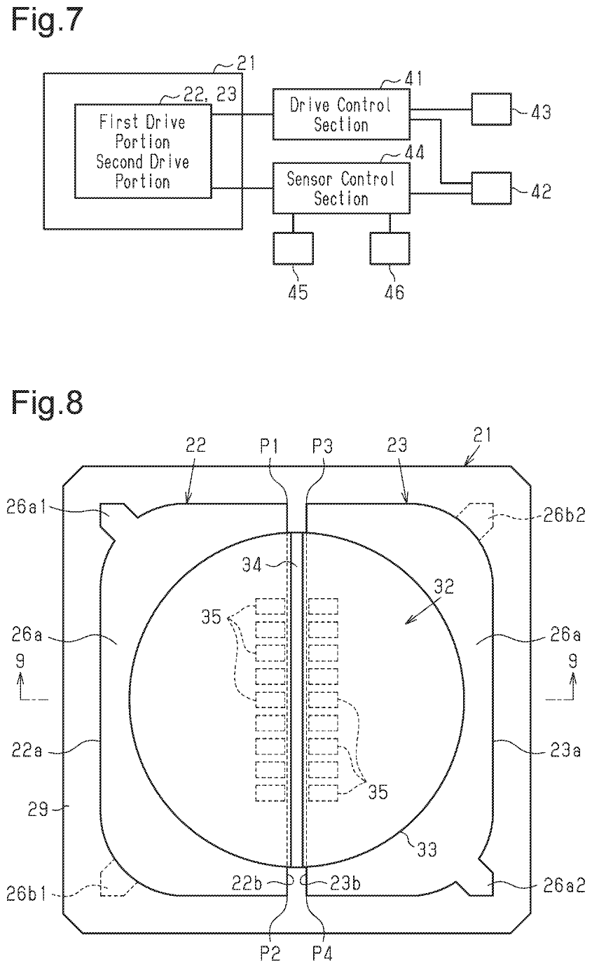

With reference to FIG. 7, the sensor control section 44 of the second embodiment is electrically connected to the first and second drive portions 22, 23 through the contacts 26a1, 26a2, 26b1, 26b2. The sensor control section 44 is configured to apply a sufficiently small AC voltage between the drive electrode layers 26 of each of the first and second drive portions 22, 23, compared to the voltage applied by the drive control section 41, and obtain the capacitance between the drive electrode layers 26. The sensor control section 44 is also configured to estimate the external force that presses each of the first and second drive portions 22, 23 of the soft membrane 21, based on the obtained capacitance and the voltage applied by the drive control section 41.

The notification device 45 is configured to display and announce the external force estimated by the sensor control section 44 or information based on the estimated external force. The recording device 46 is configured to record and accumulate the external force estimated by the sensor control section 44 or the information based on the estimated external force. In the second embodiment, the external force acting on the first and second drive portions 22, 23 correspond to the information based on the load applied to the simulated body 32. The first drive portion 22, the second drive portion 23. and the sensor control section 44 constitute the load sensor.

In addition to the advantages (1) to (4) and (6) to (8) of the first embodiment, the second embodiment has the following advantages.

(9) The first drive portion 22 and the second drive portion 23 function as the sensor portions 24. In other words, the first and second drive portions 22, 23 serve also as the sensor portions 24. The drive dielectric layers 25 correspond to the sensor dielectric layers 27. The drive electrode layers 26 correspond to the sensor electrode layers 28.

In the above-described configuration, since the first drive portion 22 and the second drive portion 23 serve also as the sensor portions 24, the configuration of the soft membrane 21 is simplified. Also, the first and second drive portions 22, 23 are arranged in a wider range of the soft membrane 21. This enhances flexibility in the designing of the first and second drive portions 22, 23.

### Third Embodiment

An operation simulator according to a third embodiment will hereafter be described. The operation simulator of the third embodiment has a load sensor configured differently from the load sensor according to the first embodiment. The description below will thus focus on this difference. Components of the third embodiment that are identical with or correspond to corresponding components of the first and second embodiments will be cited with reference numerals that are common with corresponding reference numerals of the first and second embodiments. Description of these components will not be repeated.

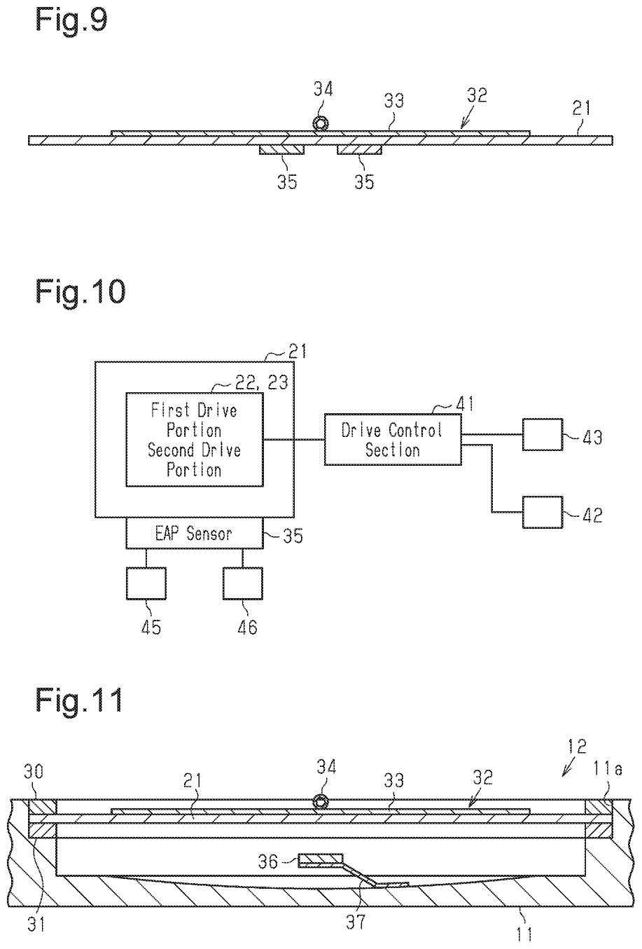

As illustrated in FIGS. 8 and 9, the soft membrane 21 of the third embodiment lacks the sensor portions 24, unlike the soft membrane 21 of the first embodiment. The first drive portion 22 and the second drive portion 23 are provided substantially in the entire soft membrane 21 such that the opposed edge sections 22b, 23b extend linearly.

Electroactive polymer sensors 35 (hereinafter, referred to as EAP sensors 35) each serving as a load sensor are fixed to a central section of the lower surface of the soft membrane 21 using adhesive. The EAP sensors 35 are soft sheet-like piezoelectric elements made of electroactive polymer material and each output an electric signal corresponding to the external force applied to the EAP sensor 35. The EAP sensors 35 may be, for example, sensors using electroactive polymer such as dielectric elastomer, electrostrictive relaxor ferroelectric polymer, piezoelectric polymer, ferroelectric polymer, electrostatic shrinkage polymer, liquid crystal polymer, ionic polymer-metal composite, mechanochemical polymer, mechanochemical gel, ion-exchange resin film-metal composite, or polymer carbon nanotube.

In a plan view, the outline and location of each of the EAP sensors 35 are substantially identical with or the same as the outline and position of the corresponding one of the sensor portions 24, which are disposed in the soft membrane 21 of the first embodiment. Therefore, the EAP sensors 35 are each placed on the corresponding one of the first and the second drive portions 22, 23 of the soft membrane 21 in the thickness direction of the soft membrane 21. As in the first embodiment, the simulated blood vessel 34 of the simulated body 32 is arranged to pass between the first drive portion 22 and the second drive portion 23 in a direction along the surface of the soft membrane 21 and between the adjacent pairs of the EAP sensors 35 in the transverse direction.

With reference to FIG. 10, the notification device 45 and the recording device 46 are connected to the EAP sensors 35. The notification device 45 is configured to display and announce the external force applied to each of the EAP sensors 35 through the simulated body 32 and the soft membrane 21, based on an electric signal output by the EAP sensor 35. The recording device 46 is configured to record and accumulate the external force applied to each EAP sensor 35. In the third embodiment, a parameter corresponding to the applied external force, such as the voltage output by each EAP sensor 35, corresponds to the information based on the load applied to the simulated body 32. The EAP sensors 35 each constitute the load sensor.

In addition to the advantages (1), (4) and (6) to (8) of the first embodiment, the third embodiment has the following advantages.

(10) The load sensors are the EAP sensors 35, which are attached to the soft membrane 21.

The above-described configuration detects a change in the load applied to the soft membrane 21 through the simulated body 32 as a change in the electric signal output by each EAP sensor 35. The operation simulator is thus adapted for quantitative determination of the load applied to the simulated body 32. Also, since the EAP sensors 35 are disposed at such positions that the EAP sensors 35 are each placed on the corresponding first or second drive portion 22, 23 in the thickness direction of the soft membrane 21, detecting portions may be arranged with improved flexibility.

The EAP sensors 35 are attached to the soft membrane 21.

The information detected by the operation simulator, which has the above-described configuration, is also used as reference for determining positions at which the load is applied. As a result, the operation simulator effectively improves the techniques of decreasing undesirable load on living tissue.

### Fourth Embodiment

An operation simulator according to a fourth embodiment will hereafter be described. The operation simulator of the fourth embodiment has a load sensor configured differently from the load sensor according to the third embodiment. The description below will thus focus on this difference. Components of the fourth embodiment that are identical with or correspond to corresponding components of the first to third embodiments will be cited with reference numerals that are common with corresponding reference numerals of the first to third embodiments. Description of these components will not be repeated.

As illustrated in FIG. 11, the soft membrane 21 of the fourth embodiment lacks the EAP sensors 35, unlike the soft membrane 21 of the third embodiment. The operation simulator of the fourth embodiment has a single contact sensor 36 as a load sensor replacing the EAP sensors 35. The contact sensor 36 is attached to the case 11.

The contact sensor 36 is attached to the case 11 through a leaf-spring-like support body 37. The support body 37 can be elastically displaced in the vertical direction. The contact sensor 36 is arranged below the central section of the soft membrane 21 at the position spaced from the soft membrane 21 by a certain distance that is set in advance.

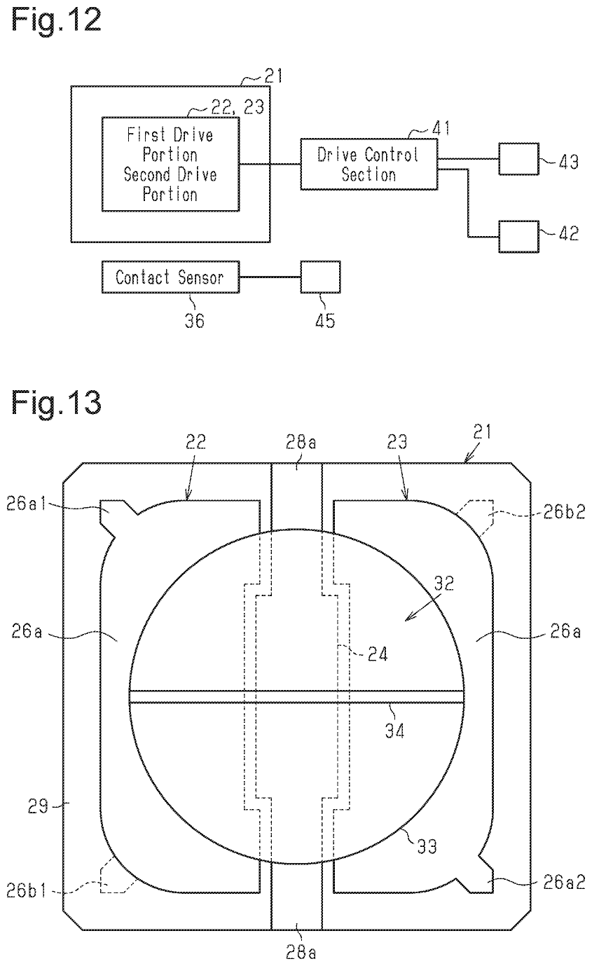

Referring to FIG. 12, the notification device 45 is connected to the contact sensor 36. The notification device 45 is configured to generate an alarm sound at the time the contact sensor 36 and the soft membrane 21 come into contact with each other, In the fourth embodiment, whether the soft membrane 21 and the contact sensor 36 are in contact with each other corresponds to the information based on the load applied to the simulated body 32. The contact sensor 36 constitutes the load sensor.

When a simulated operation is performed using the operation simulator of the fourth embodiment and the simulated body 32 is excessively pressed by an operation tool, the soft membrane 21 contacts the contact sensor 36, thus causing the notification device 45 to generate an alarm sound. Hearing the alarm sound, the operator understands that the manipulation immediately before such alarming has been a manipulation that may cause a great undesirable load on living tissue. Therefore, by performing a simulated operation in a manner not to generate an alarm sound, the operator improves the techniques of decreasing undesirable load on living tissue.

The operation simulator according to the fourth embodiment has the advantages (1), (4), (6), and (8) of the first embodiment.

The embodiments described above may be modified as follows. The above-described embodiments and the following modifications can be combined as long as the combined modifications remain technically consistent with each other.

The information detected by load sensors is not restricted in any particular manner as long as the information is based on the load applied to the simulated body 32. For example, although the deformation amount of each sensor portion 24 estimated from the capacitance between the sensor electrode layers 28 of the sensor portion 24 is employed as the aforementioned information in the first embodiment, the capacitance between the sensor electrode layers 28 may be used directly as the information. Alternatively, as in the second embodiment, the external force pressing each sensor portion 24 may be estimated from the capacitance between the sensor electrode layers 28 of the sensor portion 24 and the estimated external force may be used as the information.

The first embodiment has the multiple sensor portions 24. The sensor portions 24 are arranged between the adjacent drive portions (the first drive portion 22 and the second drive portion 23) in a direction along the surface of the soft membrane 21. However, the number and locations of the sensor portions 24 in the soft membrane 21 are not restricted in any particular manner. For example, as shown in FIG. 13, a single large-sized sensor portion 24 may be disposed in the central section of the soft membrane 21.

Similarly, the number and locations of the EAP sensors 35 in the soft membrane 21 of the third embodiment are not restricted in any particular manner. The EAP sensors 35 may be attached to the upper surface of the soft membrane 21.

The fourth embodiment may have multiple contact sensors 36. Alternatively, instead of the contact sensors 36, a position sensor may be attached to the soft membrane 21. In this case, the notification device 45 is configured to generate an alarm sound at the time, for example, the simulated body 32 is excessively pressed in a simulated operation and the position sensor is caused to reach a certain position that is set in advance.

The dielectric elastomer of which the drive dielectric layers 25 and the sensor dielectric layers 27 are made is not restricted to polyrotaxane and may be any other dielectric elastomer such as silicone elastomer, acrylic elastomer, and urethane elastomer.

The insulating polymer contained in the conductive elastomer of which the drive electrode layers 26 and the sensor electrode layers 28 are made is not restricted to polyrotaxane and may be any other insulating polymer such as silicone elastomer, acrylic elastomer, and urethane elastomer. One of the cited insulating polymers may be employed alone. Also, two or more of the cited insulating polymers may be employed in combination.

The conductive filler contained in the conductive elastomer of which the drive electrode layers 26 and the sensor electrode layers 28 are made is not restricted to Ketjen black and may be any other carbon black, carbon nanotube, or metal particles such as copper or silver particles. One of the cited conductive fillers may be employed alone. Also, two or more of the cited conductive fillers may be employed in combination. Alternatively, layers made directly of any of the cited conductive filler materials may be employed.

The above-described embodiments employ, by way of example, the soft membrane 21 including the two drive portions, that is, the first and second drive portions 22, 23. However, the soft membrane 21 may include either three or more drive portions or a single drive portion.

The configuration of each drive portion for driving the soft membrane 21 to move the simulated body 32 in a manner simulating relaxation and contraction of living tissue is not restricted to the configuration using a dielectric elastomer actuator. For example, the drive portion may be configured using an electroactive polymer actuator employing the aforementioned electroactive polymer.

Alternatively, the drive portions may be provided separately from the soft membrane 21. For example, a different actuator such as an actuator including a wire made of a shape memory alloy may be used to reciprocate a soft membrane and a frame member supporting the soft membrane in the vertical direction. The soft membrane is made of elastomer and has the elasticity characteristics that have been cited by way of example for the above-described embodiments.

The operation simulator is not restricted to the use in training for off-pump coronary bypass surgery and may be used in training for operation on any living tissue that selectively relaxes and contracts other than the heart, such as catheter intervention. Alternatively, the operation simulator may be used in training for operation on any living tissue that does not relax or contract. In this case, the drive portions that drive the soft membrane 21 to move the simulated body 32 in a manner simulating the relaxation and contraction of living tissue may be omitted.

The operation simulator may be used for any other purpose than training for operation, such as obtaining and analyzing quantitative data regarding operation techniques.

The location of the simulated blood vessel 34 in the simulated body 32 is not restricted in any particular manner and may be changed as needed in correspondence with the content of the training. For example, as shown in FIG. 13, the simulated blood vessel 34 may be arranged to extend over the first drive portion 22 and the second drive portion 23.

The number of operation sites, including the simulated blood vessel 34 in the simulated body 32, is not restricted to any particular manner and two or more operation sites may be provided. In this case, multiple simulated operations for operation training may be performed using the single simulated body 32.

The method by which the notification device 45 performs notification is not restricted in any particular manner. The notification device 45 thus may employ various types of notification methods using video, sound, or vibration.

Components other than the case 11 and the body portion 12, such as the drive control section 41, the input device 43, the notification device 45, and the recording device 46, may be mounted in the operation simulator or an external device that is connected to the operation simulator. The external device may be, for example, a tablet terminal functioning as the drive control section 41, the input device 43, the notification device 45, and the recording device 46.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure,

What is claimed is:

1. An operation simulator for an operation on living tissue, comprising:
a simulated body that simulates the living tissue;
a soft membrane that supports the simulated body; and
a load sensor that is configured to detect information based on a load applied to the simulated body.

2. The operation simulator according to claim 1, wherein
the soft membrane includes at least one sensor portion that constitutes the load sensor, and
the sensor portion includes
a sensor dielectric layer made of dielectric elastomer, and
sensor electrode layers that are made of conductive elastomer and sandwich the sensor dielectric layer.

3. The operation simulator according to claim 2, wherein
the soft membrane includes a drive portion that is configured to drive the soft membrane move the simulated body in a manner simulating relaxation and contraction of the living tissue, and
the drive portion is a dielectric elastomer actuator that includes
a drive dielectric layer made of dielectric elastomer, and
drive electrode layers that are made of conductive elastomer and sandwich the drive dielectric layer.

4. The operation simulator according to claim 3, wherein the sensor portion is provided separately from the drive portion.

5. The operation simulator according to claim 3, wherein
the drive portion functions also as the sensor portion,
the drive dielectric layer corresponds to the sensor dielectric layer, and
the drive electrode layers correspond to the sensor electrode layers.

6. The operation simulator according to claim 1, wherein the load sensor is at least one electroactive polymer sensor that is attached to the soft membrane.

7. The operation simulator according to claim 1, comprising a drive portion that is configured to drive the soft membrane to move the simulated body in a manner simulating relaxation and contraction of the living tissue.
